(19) United States
(12) Patent Application Publication
(10) Pub. No.: US 2026/0134704 A1
(43) Pub. Date: May 14, 2026

(54) VIDEO PANOPTIC SEGMENTATION

(71) Applicant: SAMSUNG ELECTRONICS CO., LTD., SUWON-SI (KR)

(72) Inventors: QINGFENG LIU, SAN DIEGO, CA (US); MOSTAFA EL-KHAMY, SAN DIEGO, CA (US); KEE-BONG SONG, SAN DIEGO, CA (US)

(21) Appl. No.: 19/388,458

(22) Filed: Nov. 13, 2025

Related U.S. Application Data
(60) Provisional application No. 63/720,658, filed on Nov. 14, 2024.
(60) Provisional application No. 63/874,899, filed on Sep. 3, 2025.

(51) Int. Cl. G06V 20/70; G06V 10/82

(52) U.S. Cl. CPC G06V 20/70; G06V 10/82

(57) ABSTRACT

A method, apparatus, and product for video panoptic segmentation are disclosed. Such video panoptic segmentation includes generating, by a convolutional neural network encoder of a video panoptic segmentation system, multi-scale feature maps from a sequence of video frames, the system further including a pixel decoder, a transformer decoder, and an online tracker. The method further includes refining the multi-scale feature maps to produce mask feature representations and producing, by the transformer decoder, query embeddings and mask predictions from the refined mask feature representations. The method also includes matching the query embeddings for a current frame with query embeddings for a previous frame, refining the current-frame query embeddings based on the matched embeddings, and outputting panoptic-segmentation results based on the refined query embeddings that identify classes and instance associations across frames.

### CROSS-REFERENCE TO RELATED APPLICATIONS

This application claims the priority benefit under 35 U.S.C. § 119 (e) of U.S. Provisional Application No. 63/720,658, filed on Nov. 14, 2024, and U.S. Provisional Application No. 63/874,899, filed on Sep. 3, 2025, the disclosures of which are each incorporated by reference in their entirety as if fully set forth herein.

### TECHNICAL FIELD

The disclosure generally relates to video processing. More particularly, the subject matter disclosed herein relates to improvements to video panoptic segmentation.

### SUMMARY

Video panoptic segmentation enables a computing system to identify, segment, and track every object and background region within a video sequence. Applications that may rely on video panoptic segmentation include autonomous vehicles and advanced driver-assistance systems that detect and track road users, vehicles, and infrastructure in dynamic environments; mobile and wearable devices that enable augmented reality overlays, background substitution, or subject-aware photography; robotic and industrial automation systems that perform object recognition, manipulation, and path planning; and intelligent surveillance or smart-city sensors that identify and monitor activities, detect anomalies, and generate real-time analytics.

Conventional video panoptic segmentation techniques rely on large transformer-based architectures or other high-capacity visual foundation models that perform well on server-class hardware but impose excessive computational cost for mobile or embedded deployment. Many of these systems utilize complex multi-scale attention operations, dynamic masking procedures, or transformer-based tracking refiners that require extensive memory bandwidth and cannot operate efficiently on neural processing units integrated into mobile devices. These approaches achieve strong accuracy on benchmark datasets but cannot provide real-time, power-efficient segmentation and tracking for applications such as mobile cameras, autonomous sensing, and on-device video analytics.

Lightweight convolutional networks and simplified transformer decoders have been explored to reduce model size, yet these methods frequently sacrifice segmentation quality and temporal consistency. In particular, most existing systems process each frame independently or apply offline tracking refiners that depend on access to the entire video, which limits real-time operation. The architectures that attempt online tracking often employ heavy cross-frame attention blocks or dynamic normalization operators that are not compatible with the fixed-graph compilation environments required by mobile neural processors. As a result, prior systems exhibit inefficiency, latency, and inconsistency when deployed on resource-constrained hardware.

To overcome these issues, methods, apparatus and products are described herein for computational and energy efficient video panoptic segmentation. The disclosed video panoptic segmentation system applies a compact architecture that unifies an efficient convolutional encoder, a lightweight pixel decoder, a transformer decoder, and an online tracker that maintains temporal coherence between consecutive frames without the computational burden of traditional refiners. The architecture introduces hardware-friendly normalization, static masked attention, and recursive embedding refinement that preserve accuracy while operating within the limited computational capacity of mobile neural processors. Through this combination, the disclosed system enables real-time, on-device segmentation and tracking of multiple objects across video frames with consistent performance and energy efficiency.

The above approaches improve on previous approaches because the described system maintains segmentation accuracy while substantially reducing computational complexity and latency. In some embodiments, the integration of batch and root-mean-square normalization operations eliminates inefficient layer normalization, allowing the system to execute efficiently on mobile neural processing units without degradation in model convergence. In some embodiments, the parametric-sigmoid-based masked attention provides a static and quantizable alternative to dynamic mask computation, enabling faster inference and stable deployment within compiler-optimized environments. The online tracker refines query embeddings recursively using embeddings from previous frames, which maintains consistent instance identification across time without the need for large transformer-based refiners. These improvements produce smoother temporal segmentation, reduced power consumption, and higher frame throughput on constrained hardware platforms. The resulting system supports real-time, on-device video understanding with accuracy comparable to complex server-class architectures while delivering the responsiveness and energy efficiency required for embedded and mobile applications.

In an embodiment, a method includes generating, by a convolutional neural network encoder of a video panoptic segmentation system, multi-scale feature maps from a sequence of video frames, where the video panoptic segmentation system further includes a pixel decoder, a transformer decoder, and an online tracker. The method further includes refining the multi-scale feature maps to produce mask feature representations. The method further includes producing, by the transformer decoder, query embeddings and mask predictions from the mask feature representations refined by the pixel decoder. The method further includes matching, by the video panoptic segmentation system, the query embeddings for a current frame with query embeddings for a previous frame. The method further includes refining, by the online tracker, the query embeddings of the current frame based on the matched query embeddings of the previous frame. The method further includes outputting, by the video panoptic segmentation system, panoptic-segmentation results based on the refined query embeddings that identify classes and instance associations across the sequence of video frames. In an embodiment, a system comprises

In an embodiment, an apparatus includes a memory and a processing device operatively coupled to the memory. The processing device is configured to generate, by a convolutional neural network encoder of a video panoptic segmentation system, multi-scale feature maps from a sequence of video frames, where the video panoptic segmentation system further includes a pixel decoder, a transformer decoder, and an online tracker. The processing device is further configured to refine the multi-scale feature maps to produce mask feature representations. The processing device is further configured to produce, by the transformer decoder, query embeddings and mask predictions from the mask feature representations refined by the pixel decoder. The processing device is further configured to match, by the video panoptic segmentation system, the query embeddings for a current frame with query embeddings for a previous frame. The processing device is further configured to refine, by the online tracker, the query embeddings of the current frame based on the matched query embeddings of the previous frame. The processing device is further configured to output, by the video panoptic segmentation system, panoptic-segmentation results based on the refined query embeddings that identify classes and instance associations across the sequence of video frames.

In an embodiment, a computer program product includes a computer-storage medium storing instructions that, when executed by a processing device, cause the processing device to generate, by a convolutional neural network encoder of a video panoptic segmentation system, multi-scale feature maps from a sequence of video frames, where the video panoptic segmentation system further includes a pixel decoder, a transformer decoder, and an online tracker. The instructions further cause the processing device to refine the multi-scale feature maps to produce mask feature representations. The instructions further cause the processing device to produce, by the transformer decoder, query embeddings and mask predictions from the mask feature representations refined by the pixel decoder. The instructions further cause the processing device to match, by the video panoptic segmentation system, the query embeddings for a current frame with query embeddings for a previous frame. The instructions further cause the processing device to refine, by the online tracker, the query embeddings of the current frame based on the matched query embeddings of the previous frame. The instructions further cause the processing device to output, by the video panoptic segmentation system, panoptic-segmentation results based on the refined query embeddings that identify classes and instance associations across the sequence of video frames.

### BRIEF DESCRIPTION OF THE DRAWING

In the following section, the aspects of the subject matter disclosed herein will be described with reference to exemplary embodiments illustrated in the figures, in which:

FIG. 1 sets forth an example video panoptic segmentation system configured according to embodiments of the present disclosure.

FIG. 2 sets forth a flow chart illustrating an example method of video panoptic segmentation according to embodiments of the present disclosure.

FIG. 3 sets forth a flow chart illustrating another example method of video panoptic segmentation and tracking using multi-scale feature refinement according to embodiments of the present disclosure.

FIG. 4 sets forth a flow chart illustrating another example method of video panoptic segmentation and tracking using a parametric-sigmoid-based masked-attention operation according to embodiments of the present disclosure.

FIG. 5 sets forth a flow chart illustrating another example method of video panoptic segmentation and tracking using normalization operations for improved computational efficiency according to embodiments of the present disclosure.

FIG. 6 sets forth a flow chart illustrating another example method of video panoptic segmentation and tracking with recursive temporal refinement according to embodiments of the present disclosure.

FIG. 7 sets forth a flow chart illustrating another example method of video panoptic segmentation and tracking with temporal aggregation of classification results according to embodiments of the present disclosure.

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

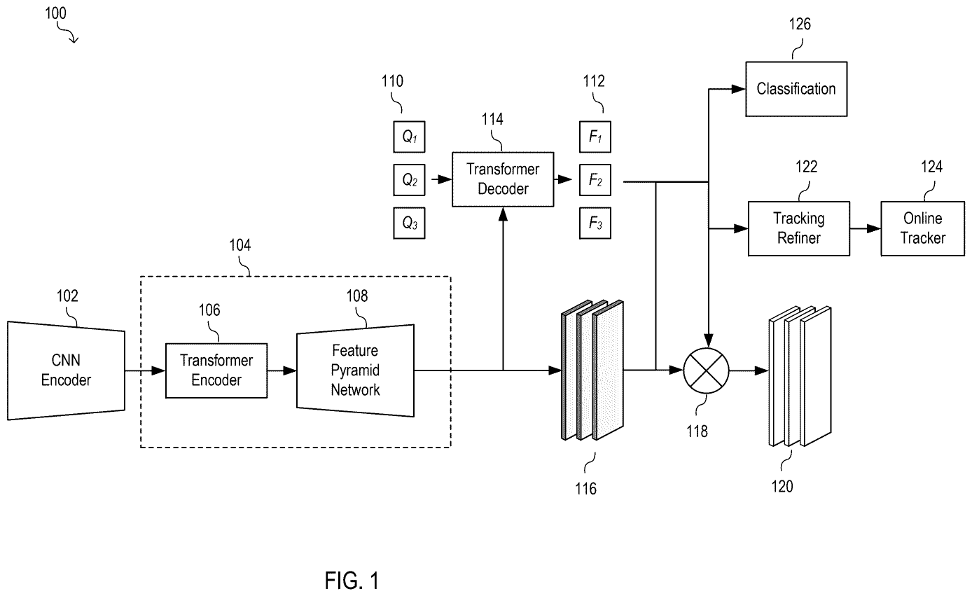

For further explanation, FIG. 1 sets forth a block diagram of an example video panoptic segmentation system 100 configured for computational and energy-efficient video segmentation and tracking in accordance with embodiments of the present disclosure. Video panoptic segmentation system 100 may be implemented in resource-constrained computing environments, such as mobile or embedded systems that include neural processing units. In such environments, the system may perform multi-frame video analysis with limited memory and computational bandwidth, while maintaining temporal consistency and real-time processing capability across successive video frames.

The example video panoptic segmentation system 100 of FIG. 1 may include a convolutional neural network (CNN) encoder 102, a pixel decoder 104, a transformer decoder 114, a tracking refiner 122, an online tracker 124, and a classification module 126. Pixel decoder 104 may further include a transformer encoder 106 and a feature pyramid network 108. Transformer decoder 114 may interact with a plurality of learnable query embeddings 110 to produce updated query embeddings 112 that represent detected instances within a video frame. Combination node 118 may combine the updated query embeddings 112 with mask feature representations 116 generated by pixel decoder 104 to produce mask predictions 120 that define instance-level segmentation boundaries. Tracking refiner 122 may operate in conjunction with online tracker 124 to perform temporal refinement of embeddings, maintaining consistent instance representations across sequential frames. Collectively, these components may provide a compact, hardware-efficient framework for real-time panoptic segmentation and instance tracking in video sequences.

In the example video panoptic segmentation system 100 of FIG. 1, the CNN encoder 102 may receive a sequence of input video frames and may extract multi-scale feature maps that represent spatial and semantic characteristics of the visual content. CNN encoder 102 may include a lightweight convolutional neural network backbone that is optimized for execution on hardware accelerators such as neural processing units. In some embodiments, CNN encoder 102 may generate multiple sets of feature maps at different spatial resolutions, for example, one-quarter, one-eighth, one-sixteenth, and one-thirty-second of the input image resolution. These multi-scale feature maps may capture both coarse semantic context and fine-grained structural detail. The output of CNN encoder 102 may be transmitted to pixel decoder 104 for further feature refinement and integration.

In the example video panoptic segmentation system 100 of FIG. 1, the CNN encoder 102 may receive a sequence of input video frames and may extract multi-scale feature maps that represent spatial and semantic characteristics of the visual content. The input video frames may be received from an image capture device, such as a mobile or embedded camera. A convolutional neural network is a hierarchical arrangement of computational layers that apply convolutional operations to an input image or feature representation to detect spatial patterns, such as edges, textures, and object structures, at progressively higher levels of abstraction. Each convolutional layer may include a set of learnable filters that operate over local receptive fields to capture visual features while preserving spatial relationships within the data. CNN encoder 102 may include a lightweight convolutional neural network backbone that is optimized for execution on hardware accelerators such as neural processing units. Examples of lightweight convolutional neural network backbones may include architectures such as ConvNeXt-Pico, MobileNet, EfficientNet-Lite, or ShuffleNet, each designed to achieve a favorable balance between computational efficiency and representational capacity. In some embodiments, CNN encoder 102 may generate multiple sets of feature maps at different spatial resolutions, for example, one-quarter, one-eighth, one-sixteenth, and one-thirty-second of the input image resolution. A feature map may refer to a two-dimensional array of numerical values that encodes the presence and strength of learned visual features at corresponding spatial locations within an image. The term “learned” may refer to patterns or parameters that are determined automatically during the network's training process through optimization, rather than being manually specified. These learned parameters may enable the network to recognize specific spatial or semantic characteristics in visual data that are relevant to a segmentation or classification task. Each element in a feature map may represent the activation of a specific filter at a given pixel position, allowing the network to capture patterns across the image domain. The term “filter” may refer to a small matrix of weights that is convolved with the input data to detect specific types of local patterns, such as edges, corners, color gradients, or textures. Each filter may specialize in identifying a particular visual characteristic, and the activations of many filters in combination may represent complex visual structures within the image. The spatial resolution of a feature map may indicate the relative size or scale of that representation compared to the original input frame. Higher-resolution feature maps may preserve finer spatial detail but contain less semantic abstraction, whereas lower-resolution feature maps may provide broader semantic context while omitting fine-grained information. These multi-scale feature maps may capture both coarse semantic context and fine-grained structural detail. The output of CNN encoder 102 may be transmitted to pixel decoder 104 for further feature refinement and integration.

In the example video panoptic segmentation system 100 of FIG. 1, CNN encoder 102 may apply normalization operations within its convolutional layers to stabilize training and improve inference performance. Normalization may refer to a process that rescales or re-centers intermediate activations within the network to maintain consistent statistical properties across feature maps, thereby improving convergence during training and enhancing numerical stability during execution. In some embodiments, CNN encoder 102 may implement layer normalization, which normalizes activations across the features of each data sample by computing their mean and variance. Layer normalization may help balance feature magnitudes across different channels of the network, enabling consistent gradient propagation through deep architectures. In other embodiments, CNN encoder 102 may implement alternative normalization techniques such as batch normalization or root mean square (RMS) normalization. Batch normalization may normalize activations across a batch of training samples, improving generalization and accelerating convergence, while RMS normalization may normalize activations based on the root mean square of the feature values without subtracting the mean, reducing computational complexity and improving efficiency on hardware accelerators such as neural processing units. These normalization alternatives may be selected based on the computational capabilities of the target hardware platform to achieve efficient and stable operation during both training and inference.

In the example video panoptic segmentation system 100 of FIG. 1, the pixel decoder 104 may receive feature maps from CNN encoder 102 and may refine the extracted features to generate intermediate feature representations that are suitable for segmentation and instance tracking. The term “refine” may refer to operations that enhance or reorganize the information contained within feature maps to improve their suitability for downstream tasks, such as object segmentation and temporal association. Refinement may include increasing semantic coherence, reducing redundancy, emphasizing object boundaries, or aligning features from different spatial resolutions. The term “features” may refer to numerical descriptors that encode visual attributes identified by CNN encoder 102, such as edges, textures, shapes, or contextual patterns present in the video frames. The term “feature representations” may refer to structured collections of features arranged in a spatial or semantic format that allows subsequent processing components, such as transformer decoder 114 or tracking refiner 122, to utilize the encoded information for classification, mask generation, and object tracking.

Pixel decoder 104 may include a transformer encoder 106 and a feature pyramid network 108. Transformer encoder 106 may enhance the semantic richness of low-resolution feature maps while expanding the receptive field, and feature pyramid network 108 may integrate information across multiple spatial scales to balance global context and fine structural detail. The term “receptive field” may refer to the spatial extent of the input data that influences a single element or activation within a feature map. A larger receptive field allows a processing layer to capture relationships among distant regions of an image, enabling the model to understand how different objects or scene elements relate to one another within a broader visual context. The term “fine structural detail” may refer to the preservation of high-frequency spatial information, such as edges, contours, and textures, that define precise object boundaries and small-scale visual features. Maintaining fine structural detail may enable downstream modules, such as transformer decoder 114, to produce accurate segmentation masks that align closely with object shapes while retaining global contextual awareness.

In the example video panoptic segmentation system 100 of FIG. 1, transformer encoder 106 may operate on one or more of the lowest-resolution feature maps generated by CNN encoder 102 to enhance semantic understanding prior to multi-scale feature fusion. Transformer encoder 106 may employ an attention-based mechanism that compares relationships among all spatial positions within the input feature maps, allowing each position to incorporate contextual information from distant regions of the same frame. In some embodiments, transformer encoder 106 may apply a series of normalization and projection operations to stabilize and compress the learned representations while maintaining the relative spatial correspondence of features. This operation may expand the receptive field of the processed feature maps, enabling downstream components to interpret the global scene layout and relationships among multiple objects more effectively. Transformer encoder 106 may produce semantically enriched feature maps that contain globally contextualized representations of the visual content.

Feature pyramid network 108 of FIG. 1 may receive the semantically enriched feature maps from transformer encoder 106 along with additional higher-resolution feature maps from CNN encoder 102. Feature pyramid network 108 may combine these inputs through lateral and top-down connections, integrating fine structural detail from high-resolution features with the broad semantic context of low-resolution features. In some embodiments, feature pyramid network 108 may perform upsampling, downsampling, or additive fusion operations to align the spatial dimensions of the feature maps before merging. The unified representation produced by feature pyramid network 108 may retain both precise spatial boundary information and global semantic awareness. The output of pixel decoder 104 may include a set of mask feature representations 116 that encode refined spatial and contextual information for use by transformer decoder 114 in generating query embeddings and segmentation masks.

In the example video panoptic segmentation system 100 of FIG. 1, transformer decoder 114 may employ an attention mechanism that enables each query embedding 110 to selectively focus on relevant spatial regions within the mask feature representations 116. The attention mechanism may compute similarity scores between the query embeddings and spatial feature tokens to determine the degree of correspondence between them. In some embodiments, transformer decoder 114 may implement a masked-attention operation in which attention weights are restricted to the spatial regions associated with each instance, thereby improving segmentation precision. Traditional masked-attention implementations may rely on dynamically binarized mask thresholds that can be computationally expensive and difficult to optimize on fixed-graph neural processing units. In some embodiments, transformer decoder 114 may instead implement a parametric-sigmoid-based masked-attention mechanism in which a continuous parametric sigmoid function replaces the dynamic binarization step. The parametric sigmoid function may define attention weights using bounded numerical values, such as positive and negative scalar limits, to approximate the binary masking effect in a static and quantizable form. This operation may maintain segmentation accuracy while reducing computational overhead and improving compatibility with compiler-optimized mobile inference environments. The use of parametric-sigmoid-based masked attention within transformer decoder 114 may therefore provide stable, hardware-efficient attention computation suitable for real-time deployment.

As an example, consider that Xₗ∈R^{n×c} is the query embedding with n queries and c dimension features at l-th transformer decoder block. In addition, Qₗ=f_{q}(Xₗ₋₁)∈R^{n×c}, which is a transformation of query of the previous l−1 block. Similarly, Kₗ, Vₗ∈R^{h}^{ₗ}^{w}^{ₗ}^{×c} are hₗ×wₗ image features under transformation fₖ(·) and fᵥ(·).

In conventional transformer decoders, the masked attention block may be computed by:

$${X}_{l} = softmax ( {M}_{l - 1} + {Q}_{l} {K}_{l}^{T} ) {V}_{l} + {X}_{l - 1}$$

The attention mask Mₗ₋₁∈R^{n×h}^{ₗ}^{w}^{ₗ} is computed at each (x, y) location as follows:

$${M}_{l - 1} ( x , y ) = \{ \begin{matrix}0 & if {S}_{l - 1} ( x , y ) > 0.5 \\ - ∞ & otherwise\end{matrix}$$

Where Sₗ₋₁ is the sigmoid output of the resized mask prediction of previous l−1 block and Sₗ₋₁ (x, y)>0.5 will binarize Sₗ₋₁.

The disadvantage of this attention mask is that it contains thresholding or binarizing operation which is dynamic in nature (unknown before computation). Such dynamic behavior may be inefficient and often unsupported by mobile neural processing units. In addition, this computation also needs a threshold determination as to whether the binarized Sₗ₋₁ are all zeros (which means all background classes). This threshold determination operation is also dynamic and not well supported in mobile neural processing units.

To address these inefficiencies, the example transformer decoder 114 of FIG. 1 may implement a parametric-sigmoid-based masked-attention mechanism that replaces the dynamic binarization with a smooth, static, and quantizable formulation. In this approach, the attention mask may be defined as:

$${M}_{l - 1} ( x , y ) = α * sigmoid ( β * ( 0.5 - {S}_{l - 1} ( x , y ) ) )$$

Where α and β are a negative scalar value and a positive scalar value with large magnitude.

Consider the following example values: α=−5000.0 and β=5000.0. In this way, if Sₗ₋₁(x, y)>0.5, Mₗ₋₁(x, y) is very close to 0.0, while if Sₗ₋₁(x, y)≤0.5, Mₗ₋₁(x, y) is very close to −5000.0, which has similar effect as −∞ in the Softmax attention calculation.

This parametric sigmoid function may allow transformer decoder 114 to maintain the spatial selectivity and segmentation accuracy of the original masked-attention operation while providing static, differentiable attention weights that are well suited for mobile inference. The resulting formulation may eliminate dynamic control flow and conditional logic, enabling improved computational efficiency, numerical stability, and compatibility with compiler-optimized neural processing unit architectures.

In some embodiments, transformer decoder 114 of FIG. 1 may implement a normalization scheme optimized for hardware efficiency and numerical stability. Transformer decoder 114 may replace layer normalization operations with root mean square (RMS) normalization to reduce computational overhead and improve compatibility with compiler-optimized neural processing units. RMS normalization may normalize activations based on the root mean square of feature values without subtracting the mean, thereby simplifying computation while maintaining equivalent representational performance. This substitution may allow transformer decoder 114 to achieve faster inference speed and improved stability during both training and deployment on resource-constrained devices.

In the example video panoptic segmentation system 100 of FIG. 1, transformer decoder 114 may output updated query embeddings 112 that represent refined vectorized descriptions of object instances detected within the current video frame. Each updated query embedding 112 may encode semantic and spatial information that associates an instance with its corresponding regions within mask feature representations 116. In some embodiments, transformer decoder 114 may include multiple decoding layers that progressively refine the query embeddings 112 to improve localization and category separation. The updated query embeddings 112 may capture both global contextual information and object-level distinctions suitable for segmentation and temporal association.

The updated query embeddings 112 output from transformer decoder 114 may be provided to combination node 118, where they may be combined with the mask feature representations 116 generated by pixel decoder 104. Combination node 118 may perform a projection or multiplication operation that merges the spatial information contained in the mask feature representations 116 with the instance-level semantics encoded in the updated query embeddings 112. The resulting combined features may produce mask predictions 120, which may define per-pixel segmentation boundaries corresponding to the spatial extent of each detected instance.

Transformer decoder 114 may also transmit the updated query embeddings 112 to tracking refiner 122 and classification module 126. In the example system 100 of FIG. 1, classification module 126 may be a component configured to assign a semantic class label to each detected instance represented by a query embedding 112. The term “class” may refer to a predefined semantic category that describes the type of object or region detected within the video frame. For example, classes may include “person,” “vehicle,” “bicycle,” “animal,” “tree,” or “building,” depending on the application and training dataset. Classification module 126 may receive the updated query embeddings 112 from transformer decoder 114 and may apply one or more classification layers, such as linear projection or fully connected layers, to produce class logits representing the likelihood that a given query embedding corresponds to each defined class. The term “class logits” may refer to raw numerical outputs of a classifier, where higher logit values indicate stronger confidence that a detected instance belongs to a particular class. The term “instance” may refer to a distinct, identifiable occurrence of an object belonging to a specific class within a frame or sequence of frames. For example, two pedestrians within a video frame may each represent a separate instance of the “person” class. In some embodiments, classification module 126 may perform this classification process jointly with the generation of mask predictions 120 so that each segmented instance is associated with both a spatial mask and a corresponding semantic label. The classifications produced by classification module 126 may be combined with the refined embeddings from tracking refiner 122 and the mask predictions 120 to generate a unified output that includes per-pixel segmentation, persistent instance identifiers, and semantic class information for each object across the sequence of video frames.

In the example system 100 of FIG. 1, tracking refiner 122 may be a processing component configured to refine the query embeddings 112 of the current frame using temporal information derived from one or more previous frames. Tracking refiner 122 may receive the query embeddings 112 corresponding to the current frame and may compare them to stored query embeddings from earlier frames to identify correspondences between detected instances across time. In some embodiments, tracking refiner 122 may apply a matching algorithm, such as a Hungarian matching process, to associate each current-frame embedding with its most similar embedding from the preceding frame based on a defined similarity metric. Tracking refiner 122 may then recursively update each embedding by incorporating features from its matched counterpart, thereby maintaining consistent instance identifiers for objects that persist across frames. In some embodiments, tracking refiner 122 may also augment the refinement process using contextual information derived from mask features, enabling improved accuracy in cases of partial occlusion or motion. The refined embeddings output by tracking refiner 122 may be transmitted to online tracker 124 for temporal association and output generation.

In the example system 100 of FIG. 1, online tracker 124 may be a processing component configured to maintain consistent instance associations across sequential video frames using the refined query embeddings produced by tracking refiner 122. The term “online” may refer to a processing mode in which video frames are analyzed sequentially and in real time, such that online tracker 124 processes each current frame using only information from the current and one or more previous frames. This may be contrasted with an offline tracker, which operates on the entire video sequence after all frames have been captured and may retrospectively optimize object associations but cannot perform real-time tracking. Online tracker 124 may perform real-time temporal association by comparing the refined embeddings of the current frame with those from preceding frames to identify consistent object correspondences. In some embodiments, online tracker 124 may apply a matching algorithm, such as a Hungarian matching process or nearest-neighbor association, to maintain unique instance identifiers for objects that persist across frames. Online tracker 124 may also dynamically update or remove identifiers as objects appear or disappear from the field of view. The term “instance identifier” may refer to a unique, persistent label assigned to each tracked object that remains constant for the duration of that object's visibility. The online tracker 124 described in the example system 100 may be implemented as a lightweight or minimal online tracker that achieves performance comparable to more complex transformer-based trackers but with significantly reduced computational complexity. The outputs of online tracker 124 may include temporally consistent instance identifiers that are combined with the semantic class labels from classification module 126 and the mask predictions 120 to generate final panoptic-segmentation results representing both spatial segmentation and temporal tracking for each detected object across the video sequence.

The example online tracker 124 of FIG. 1 may be implemented in a variety of manners depending on the desired balance between computational efficiency and tracking accuracy. In some embodiments, online tracker 124 may refine the query embeddings of the current frame using temporal information derived from one or more previous frames. Online tracker 124 may perform a matching operation, such as a Hungarian matching process, to associate query embeddings of the current frame with query embeddings of the previous frame. Each matched embedding pair may then be used to compute a refined embedding by recursively combining the current-frame embedding with information from its temporal counterpart. This recursive refinement process may maintain embedding continuity over time, allowing identical objects to be represented by consistent instance identifiers across consecutive frames. This embodiment may achieve high tracking accuracy at significantly reduced computational cost relative to transformer-based refiners by using a lightweight embedding-matching and fusion operation that avoids the complexity of cross-frame transformer attention.

In another embodiment, online tracker 124 may extend the functionality of the preceding embodiment by incorporating contextual information derived from mask feature representations 116 in addition to temporal information from previous frames. Online tracker 124 may generate context embeddings by applying a mask-pooling operation to the mask feature representations 116 using a binarized sigmoid mask corresponding to each detected instance. These context embeddings may be combined with the query embeddings of the current frame to produce augmented embeddings that encode both spatial context and temporal continuity. The augmented embeddings may then be refined recursively using the same temporal matching process described above. By combining spatial and temporal cues, this embodiment may improve object association performance in scenarios involving motion, occlusion, or deformation while maintaining a lightweight and computationally efficient structure.

In some embodiments, video panoptic segmentation system 100 may further include a classification aggregation process that applies a Hungarian-matching-based exponential moving average (EMA) operation to the classification outputs generated by classification module 126. The EMA operation may aggregate mask classification logits across consecutive frames to produce temporally consistent class predictions that account for variations in appearance, illumination, or viewpoint. The use of Hungarian matching may ensure accurate correspondence between instances before averaging, allowing the aggregation to occur between correctly associated instances across frames. This process may operate separately from the instance tracking performed by online tracker 124, which maintains temporal consistency of object identifiers. The Hungarian-matching-based EMA may therefore refine the temporal stability of semantic classifications, while online tracker 124 ensures consistent instance identities. Together, these complementary processes may improve the accuracy and smoothness of the final panoptic-segmentation results while preserving the real-time, frame-by-frame operation of system 100.

The example video panoptic segmentation system 100 of FIG. 1 may generate final panoptic-segmentation results by combining outputs from multiple components operating in sequence. Transformer decoder 114 may output updated query embeddings 112. Combination node 118 may combine the updated query embeddings 112 with mask feature representations 116 to produce mask predictions 120 that define per-pixel assignments for detected instances. Classification module 126 may process the updated query embeddings 112 to produce semantic class labels for the detected instances. Tracking refiner 122 may refine the updated query embeddings 112 across frames, and online tracker 124 may assign and maintain persistent instance identifiers for objects through the sequence. The final panoptic-segmentation results may therefore include, for each pixel, an association to a mask in mask predictions 120, a semantic class label produced by classification module 126, and a persistent instance identifier maintained by online tracker 124, such that the results represent pixel-level segmentation with consistent semantic classification and instance continuity across video frames.

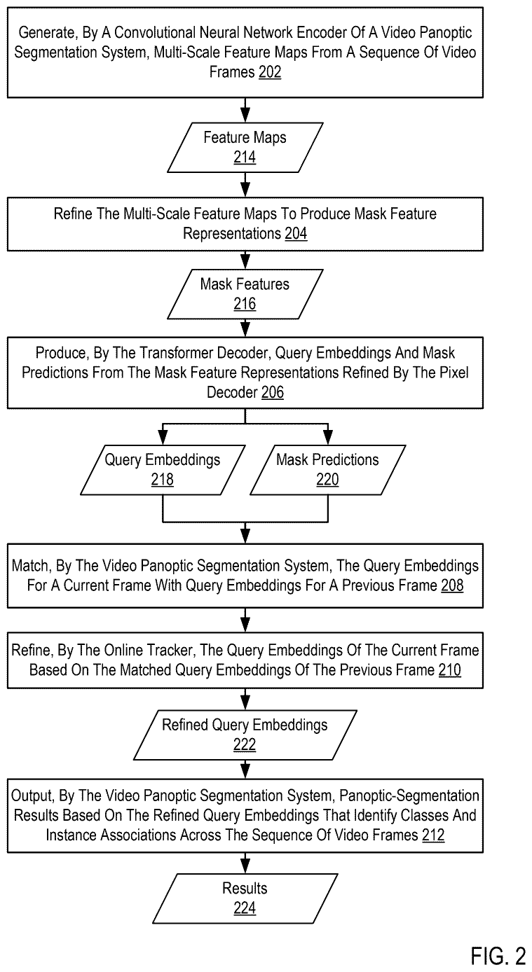

For further explanation, FIG. 2 sets forth a flow chart illustrating an example method of performing video panoptic segmentation and tracking in accordance with embodiments of the present disclosure. The example method of FIG. 2 can be carried out in a system similar to that of FIG. 1. The method of FIG. 2 can be performed by video panoptic segmentation system 100.

The method of FIG. 2 includes generating 202, by convolutional neural network (CNN) encoder 102 of video panoptic segmentation system 100, multi-scale feature maps 214 from a sequence of video frames. Generating 202 the multi-scale feature maps may be carried out by receiving video frames from an image capture device, such as a mobile or embedded camera, and processing each frame through a series of convolutional layers in CNN encoder 102. Each convolutional layer may apply learnable filters to detect spatial patterns such as edges, textures, or object boundaries. CNN encoder 102 may output multi-scale feature maps 214 at multiple spatial resolutions, such as one-quarter, one-eighth, one-sixteenth, and one-thirty-second of the original input resolution. The multi-scale feature maps 214 may capture both fine structural detail and broader semantic context of the input video frames for subsequent refinement by downstream components.

The method of FIG. 2 also includes refining 204 the multi-scale feature maps to produce mask feature representations 216. Refining 204 the multi-scale feature maps may be carried out by pixel decoder 104, which may include transformer encoder 106 and feature pyramid network 108. Transformer encoder 106 may enhance the semantic richness of the lowest-resolution feature maps by applying attention-based operations that relate spatial positions within each frame to one another. Feature pyramid network 108 may integrate high-resolution and low-resolution feature maps through lateral and top-down connections, preserving fine object boundaries while maintaining global scene awareness. The resulting mask feature representations 216 may include refined spatial and semantic information used for segmentation and mask generation.

The method of FIG. 2 also includes producing 206, by transformer decoder 114, query embeddings 218 and mask predictions 220 from the mask feature representations 216 refined by pixel decoder 104. Producing 206 the query embeddings 218 and the mask predictions 220 may be carried out by initializing a set of learnable query embeddings 218 that represent potential object instances and passing them through transformer decoder 114. Transformer decoder 114 may apply attention operations to associate each query embedding with the most relevant spatial features within mask feature representations 216. In some embodiments, transformer decoder 114 may employ a parametric-sigmoid-based masked-attention mechanism to improve computational efficiency and quantization compatibility for mobile neural processing units. The transformer decoder 114 may output updated query embeddings 218 that encode instance-level information, which may be combined with mask feature representations 216 at combination node 118 to generate mask predictions 220 representing per-pixel segmentations for each detected instance.

The method of FIG. 2 also includes matching 208, by video panoptic segmentation system 100, the query embeddings 218 for a current frame with query embeddings for a previous frame. Matching 208 the query embeddings 218 may be carried out by comparing the updated query embeddings of the current frame with the stored query embeddings from the previous frame to establish correspondence between detected instances across time. In some embodiments, matching 208 may utilize a Hungarian matching process that optimally associates current-frame embeddings with their most similar previous-frame counterparts based on similarity metrics such as cosine similarity or Euclidean distance. Matching 208 may thereby enable temporal consistency by ensuring that the same physical objects are correctly identified across consecutive frames.

The method of FIG. 2 also includes refining 210, by online tracker 124, the query embeddings 218 of the current frame based on the matched query embeddings of the previous frame. Refining 210 the query embeddings 218 (to produce refined query embeddings 222) may be carried out by recursively combining each current-frame query embedding with information from its matched embedding in the previous frame to generate refined query embeddings 222. In some embodiments, online tracker 124 may refine the query embeddings using only temporal information from prior frames, while in other embodiments, online tracker 124 may also use contextual information derived from mask feature representations 116 to improve performance in cases of occlusion or motion. The recursive refinement process may maintain consistent instance identifiers for each object across frames while minimizing computational cost.

The method of FIG. 2 also includes outputting 212, by video panoptic segmentation system 100, panoptic-segmentation results 224 based on the refined query embeddings 222 that identify classes and instance associations across the sequence of video frames. Outputting 212 the results 224 may be carried out by combining mask predictions 220, semantic classifications from classification module 126, and persistent instance identifiers from online tracker 124. The final panoptic-segmentation results 224 may include, for each pixel in the video sequence, a corresponding segmentation mask, a semantic class label, and a consistent instance identifier. These results may provide unified spatial and temporal information describing each detected object within the sequence, enabling real-time, on-device segmentation and tracking suitable for deployment in mobile and embedded systems.

The panoptic-segmentation results 224 generated according to the method of FIG. 2 may be used in a variety of applications that benefit from real-time understanding of visual scenes. For example, in autonomous or assisted driving systems, the results may enable precise detection, segmentation, and tracking of surrounding vehicles, pedestrians, and road infrastructure to support navigation and collision avoidance. In mobile camera applications, the results may support augmented reality rendering, background replacement, or automatic focus adjustment based on detected subjects within each frame. In industrial automation or robotics, the results may facilitate dynamic object tracking and manipulation, allowing robotic systems to interact with moving parts or materials in real time. In smart surveillance systems, the results may be used to monitor object movement and classify detected entities across consecutive frames to improve event recognition and anomaly detection. The lightweight and hardware-efficient nature of video panoptic segmentation system 100 may allow these capabilities to be integrated into resource-constrained platforms, enabling accurate, temporally consistent video understanding in embedded or mobile deployments.

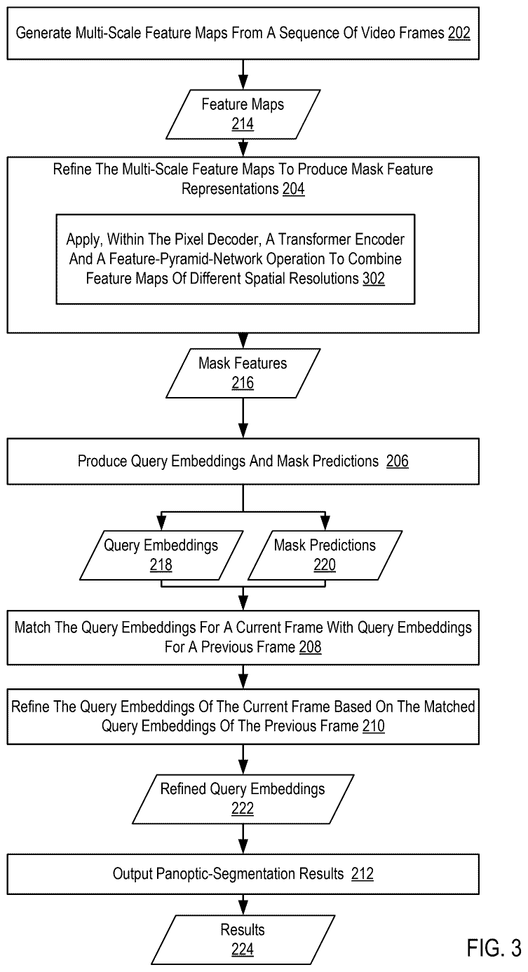

For further explanation, FIG. 3 sets forth a flow chart illustrating another example method of performing video panoptic segmentation and tracking using multi-scale feature refinement in accordance with embodiments of the present disclosure. The method of FIG. 3 is similar to the method of FIG. 2 and includes generating 202, refining 204, producing 206, matching 208, refining 210, and outputting 212. The example method of FIG. 3 can be carried out in systems similar to that of FIG. 1, such as video panoptic segmentation system 100, which includes CNN encoder 102, pixel decoder 104, transformer decoder 114, tracking refiner 122, online tracker 124, and classification module 126.

In the method of FIG. 3, refining 204 the multi-scale feature maps to produce mask feature representations 216 includes applying 302, within pixel decoder 104, a transformer encoder 106 and a feature-pyramid-network operation to combine feature maps of different spatial resolutions. Applying 302, within pixel decoder 104, a transformer encoder 106 and a feature-pyramid-network operation to combine feature maps of different spatial resolutions may be carried out by processing one or more low-resolution feature maps through transformer encoder 106 to capture long-range dependencies across the frame while enhancing semantic understanding of the scene. Transformer encoder 106 may apply attention-based computations that allow each spatial position in the feature maps to reference and integrate contextual information from distant regions of the same frame. Applying 302 may further be carried out by feature pyramid network 108, which may combine high-resolution feature maps containing fine structural details with low-resolution feature maps containing global semantic context. Feature pyramid network 108 may align the spatial scales of these feature maps through upsampling, downsampling, or additive fusion operations before merging them into a unified representation. The combined feature maps produced by transformer encoder 106 and feature pyramid network 108 may form mask feature representations 216 that preserve both fine object boundaries and global contextual awareness, thereby enabling accurate, real-time panoptic segmentation suitable for deployment in mobile or embedded environments.

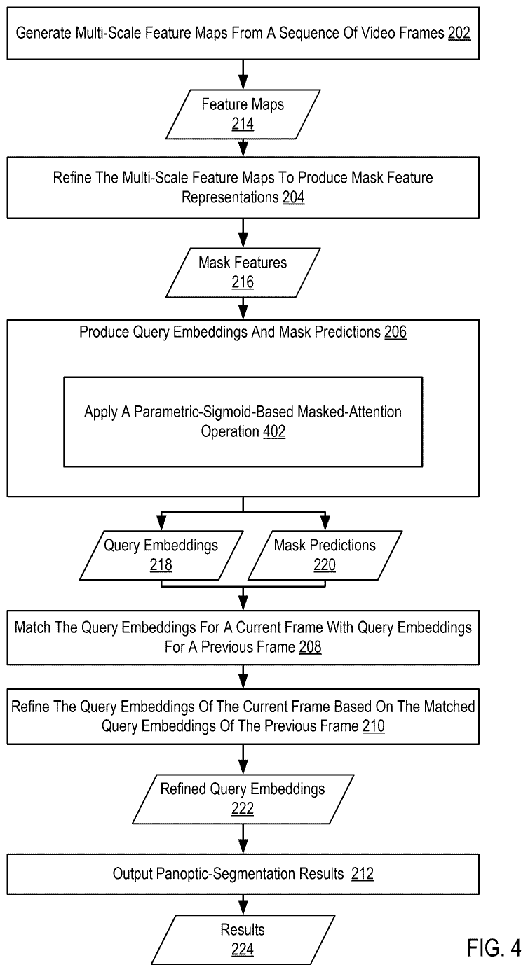

For further explanation, FIG. 4 sets forth a flow chart illustrating another example method of performing video panoptic segmentation and tracking using parametric-sigmoid-based masked attention in accordance with embodiments of the present disclosure. The method of FIG. 4 is similar to the method of FIG. 2 and includes generating 202, refining 204, producing 206, matching 208, refining 210, and outputting 212. The example method of FIG. 4 can be carried out in systems similar to that of FIG. 1, such as video panoptic segmentation system 100, which includes CNN encoder 102, pixel decoder 104, transformer decoder 114, tracking refiner 122, online tracker 124, and classification module 126.

In the method of FIG. 4, producing 206 the query embeddings and mask predictions further comprises applying 402 a parametric-sigmoid-based masked-attention operation. Applying 402 a parametric-sigmoid-based masked-attention operation may be carried out by computing attention weights that allow each query embedding 218 to focus selectively on spatial regions of mask feature representations 216 corresponding to potential object instances. The attention mask may be computed at each spatial location based on the sigmoid output of the resized mask prediction of a previous decoder block. In conventional masked-attention mechanisms, the attention mask may be dynamically binarized, which can introduce inefficiencies in mobile neural processing units. Applying 402 may therefore be carried out using a parametric-sigmoid-based formulation, as described previously in the disclosure, in which the dynamic binarization operation is replaced with a smooth, static, and quantizable function that approximates the behavior of a binary mask while remaining differentiable.

Applying 402 the parametric-sigmoid-based masked-attention operation may further include incorporating the parametric-sigmoid-based attention mask into the masked-attention computation of transformer decoder 114 as described earlier in the disclosure. This operation may allow transformer decoder 114 to compute instance-specific attention in a static and quantizable manner without relying on dynamic thresholding. The parametric-sigmoid-based masked-attention operation may maintain the segmentation accuracy of transformer decoder 114 while improving numerical stability, eliminating conditional logic, and enabling efficient inference on mobile or embedded neural processing units.

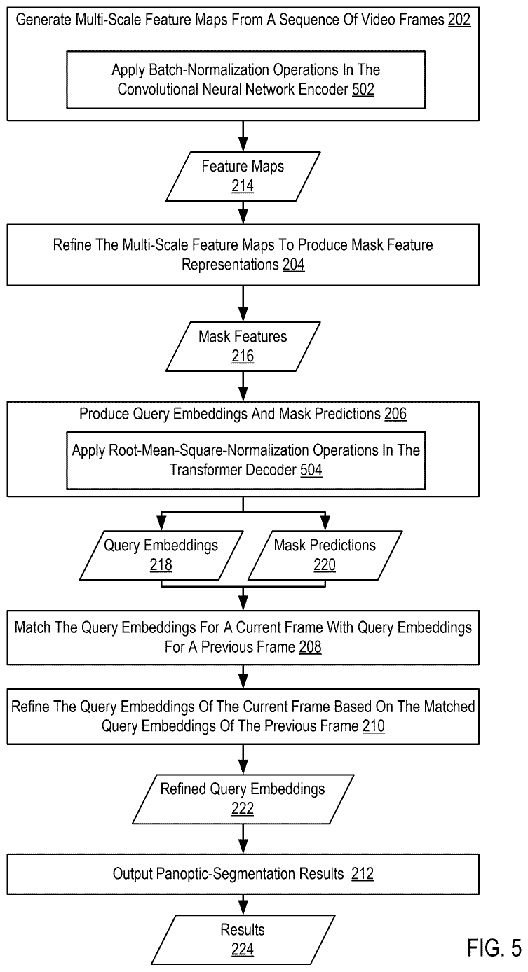

For further explanation, FIG. 5 sets forth a flow chart illustrating another example method of performing video panoptic segmentation and tracking using normalization operations for improved computational efficiency and numerical stability in accordance with embodiments of the present disclosure. The method of FIG. 5 is similar to the method of FIG. 2 and includes generating 202, refining 204, producing 206, matching 208, refining 210, and outputting 212. The example method of FIG. 5 can be carried out in systems similar to that of FIG. 1, such as video panoptic segmentation system 100, which includes CNN encoder 102, pixel decoder 104, transformer decoder 114, tracking refiner 122, online tracker 124, and classification module 126.

In the method of FIG. 5, generating 202 the multi-scale feature maps may include applying 502 batch-normalization operations in CNN encoder 102. Applying 502 batch-normalization operations in CNN encoder 102 may be carried out by normalizing activations across a batch of input video frames to stabilize learning and improve inference performance. Batch normalization may be applied to convolutional feature outputs to rescale and re-center intermediate activations, thereby maintaining consistent statistical properties across layers. This normalization may improve gradient flow during training and reduce the internal covariate shift, leading to faster convergence and more stable optimization. In some embodiments, applying 502 batch-normalization operations may also improve numerical stability during real-time inference by ensuring that the activation values of feature maps remain within a predictable range. For example, in a mobile camera or robotic vision system, batch normalization may allow CNN encoder 102 to maintain consistent feature extraction performance under varying lighting or motion conditions. The normalized feature maps may then be transmitted to pixel decoder 104 for refinement and multi-scale feature integration.

Also in the method of FIG. 5, producing 206 the query embeddings and mask predictions may include applying 504 root-mean-square-normalization (RMS normalization) operations in transformer decoder 114. Applying 504 root-mean-square-normalization operations in transformer decoder 114 may be carried out by normalizing activations within transformer decoder 114 based on the root mean square of feature values, without subtracting the mean. RMS normalization may provide comparable performance to layer normalization while reducing computational complexity and improving compatibility with compiler-optimized neural processing units. In some embodiments, applying 504 RMS normalization operations may reduce the number of arithmetic operations required for normalization, thereby lowering inference latency and power consumption on embedded or mobile hardware. For example, in a mobile video analytics application, RMS normalization may allow transformer decoder 114 to perform attention computations and mask generation efficiently while maintaining segmentation accuracy. The use of RMS normalization within transformer decoder 114 may therefore provide a hardware-efficient normalization technique that supports consistent, real-time performance of video panoptic segmentation system 100 during both training and inference.

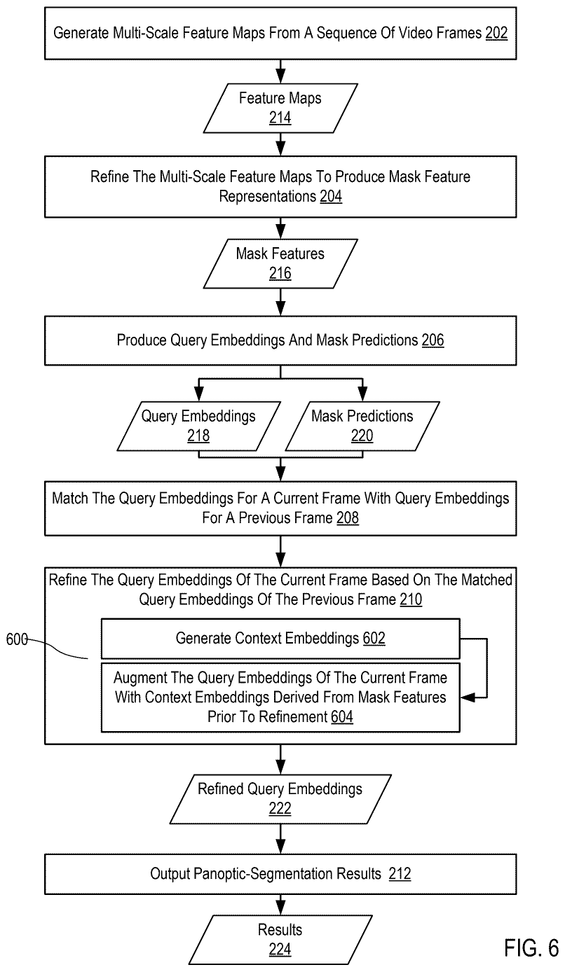

For further explanation, FIG. 6 sets forth a flow chart illustrating another example method of performing video panoptic segmentation and tracking with recursive temporal refinement in accordance with embodiments of the present disclosure. The method of FIG. 6 is similar to the method of FIG. 2 and includes generating 202, refining 204, producing 206, matching 208, refining 210, and outputting 212. The example method of FIG. 6 can be carried out in systems similar to that of FIG. 1, such as video panoptic segmentation system 100, which includes CNN encoder 102, pixel decoder 104, transformer decoder 114, tracking refiner 122, online tracker 124, and classification module 126.

In the method of FIG. 6, refining 210 the query embeddings of the current frame based on the matched query embeddings of the previous frame includes recursively incorporating 600 information from query embeddings of one or more previous frames to update the query embeddings of the current frame. Recursively incorporating 600 may be carried out by tracking refiner 122 retrieving stored query embeddings that correspond to matched instances from one or more earlier frames and combining those embeddings with current-frame query embeddings using a defined update rule. The update rule may include a weighted fusion or residual update that gradually adjusts current-frame query embeddings toward temporally consistent representations. For example, in a mobile camera application, recursively incorporating 600 may stabilize the representation of a person moving across consecutive frames; in an autonomous sensing scenario, recursively incorporating 600 may maintain consistent embeddings for a vehicle despite viewpoint or illumination changes.

In the method of FIG. 6, recursively incorporating 600 information from query embeddings of one or more previous frames to update the query embeddings of the current frame includes generating 602 the context embeddings by applying a mask-pooling operation to the mask features using binarized sigmoid masks. Generating 602 may be carried out by tracking refiner 122 receiving mask feature representations 116 from pixel decoder 104 and receiving mask predictions 120 associated with updated query embeddings from transformer decoder 114. Tracking refiner 122 may binarize the sigmoid mask predictions for each detected instance and may pool the corresponding regions of mask feature representations 116 to produce context embeddings that summarize spatial appearance and local neighborhood information for the instance. For example, in a warehouse robotics scenario, generating 602 may pool feature responses over a binarized mask of a moving package to capture texture and color cues; in a smart surveillance scenario, generating 602 may summarize the region of a tracked pedestrian to improve robustness under partial occlusion.

In the method of FIG. 6, recursively incorporating 600 information from query embeddings of one or more previous frames to update the query embeddings of the current frame also includes augmenting 604 the query embeddings of the current frame with context embeddings derived from mask features prior to refinement. Augmenting 604 may be carried out by tracking refiner 122 concatenating, projecting, or otherwise fusing the context embeddings generated in generating 602 with the current-frame query embeddings to form augmented query embeddings that encode both temporal cues and spatial appearance cues. Tracking refiner 122 may then apply the recursive update using the augmented query embeddings to produce refined query embeddings that are resilient to rapid motion, deformation, or occlusion. For example, in an aerial drone application, augmenting 604 may help maintain a consistent identifier for a vehicle turning under shadows. In an industrial inspection application, augmenting 604 may preserve the identity of a tool that becomes partially occluded by a robotic arm across successive frames.

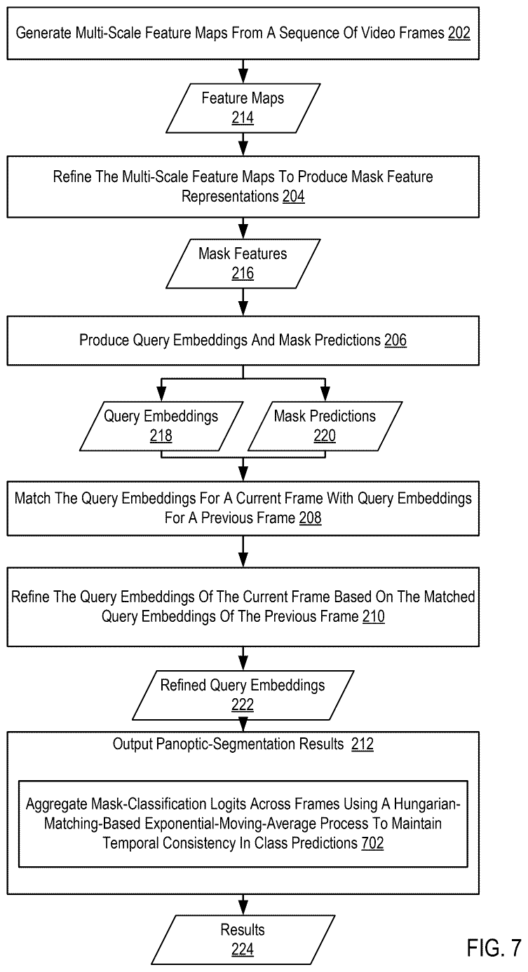

For further explanation, FIG. 7 sets forth a flow chart illustrating another example method of performing video panoptic segmentation and tracking with temporal aggregation of classification results in accordance with embodiments of the present disclosure. The method of FIG. 7 is similar to the method of FIG. 2 and includes generating 202, refining 204, producing 206, matching 208, refining 210, and outputting 212. The example method of FIG. 7 can be carried out in systems similar to that of FIG. 1, such as video panoptic segmentation system 100, which includes CNN encoder 102, pixel decoder 104, transformer decoder 114, tracking refiner 122, online tracker 124, and classification module 126.

In the method of FIG. 7, outputting 212 the panoptic-segmentation results include aggregating 702 mask-classification logits across frames using a Hungarian-matching-based exponential-moving-average (EMA) process to maintain temporal consistency in class predictions. Aggregating 702 mask-classification logits across frames may be carried out by classification module 126 in coordination with tracking refiner 122 to ensure that the same physical instances retain consistent class labels over time. Aggregating 702 mask-classification logits across frames may include applying a Hungarian matching algorithm to associate each detected instance in the current frame with the corresponding instance in one or more previous frames based on embedding similarity or spatial overlap. After correspondence is established, the mask-classification logits for each matched instance may be aggregated using an EMA process that progressively updates the class confidence scores according to weighted contributions from earlier frames.

Aggregating 702 mask-classification logits across frames may reduce class prediction fluctuations caused by appearance variations, motion blur, or changes in lighting across frames. For example, in a mobile camera application, aggregating 702 may stabilize the classification of a tracked pedestrian wearing clothing that changes appearance under different lighting conditions. In a traffic monitoring application, aggregating 702 may maintain consistent classification of a moving vehicle as it changes direction or moves between regions of varying illumination. The Hungarian-matching-based EMA process may therefore improve temporal stability of semantic classifications while preserving the real-time frame-by-frame operation of video panoptic segmentation system 100, enabling smooth and consistent class labeling for objects throughout the video sequence.

The various embodiments described herein may provide multiple technical benefits that enhance the efficiency, accuracy, and applicability of video panoptic segmentation and tracking systems. The described architectures and methods may enable real-time performance on mobile and embedded platforms by reducing computational complexity through the use of lightweight convolutional backbones, RMS and batch normalization operations, and parametric-sigmoid-based masked attention mechanisms optimized for neural processing units. The recursive refinement and context-augmented tracking processes may maintain consistent object identities and spatial accuracy across consecutive frames, improving temporal stability even under motion, occlusion, or lighting variations. The Hungarian-matching-based exponential-moving-average aggregation of classification logits may further enhance semantic consistency across time, ensuring reliable class predictions. Collectively, these features may reduce latency, power consumption, and memory demands while maintaining or exceeding the segmentation accuracy of larger, server-class models. As a result, the described systems and methods may enable deployment of advanced panoptic segmentation and tracking capabilities in resource-constrained environments such as mobile devices, robotics, autonomous vehicles, augmented reality platforms, and edge-based video analytics systems.

In some embodiments, the class labels and object tracking information generated by video panoptic segmentation system 100 may be used to perform one or more downstream operations that rely on semantic understanding of visual scenes. For example, the panoptic-segmentation results 224 may be used to enable object-based searching within live video data. A user or application may submit a search query identifying a class of interest, such as “pedestrian,” “vehicle,” or “tree,” and the system may automatically identify, index, and retrieve video segments containing corresponding classified instances. In some embodiments, the system may generate searchable metadata associating each object instance with its semantic class label and temporal position across frames, thereby enabling efficient query in video streaming systems.

In some embodiments, the classification and tracking outputs of video panoptic segmentation system 100 may be used to modify, enhance, or augment visual content based on the identified object classes or their trajectories. For example, an image or video editing application may use class labels and instance masks to remove unwanted objects from a scene, apply object-specific filters, or insert virtual elements into augmented reality environments. In a mobile camera implementation, the class and tracking data may allow real-time background replacement, selective focus control, or dynamic exposure adjustment targeted to a tracked subject, such as a moving person or vehicle. In some embodiments, the system may use the tracked class and instance data to highlight or emphasize selected objects within a live or recorded video stream. For example, during a sports broadcast, a particular player or group of players in a hockey, football, or basketball game may be dynamically highlighted, outlined, or otherwise visually distinguished from other players based on class and instance identifiers.

In some embodiments, the panoptic-segmentation results 224 may be used to support analytics, safety, or automation functions that depend on object-level awareness. For example, an autonomous navigation system for an automobile may use the tracked object positions and class information to plan trajectories that avoid collisions with pedestrians or other vehicles. A retail analytics or security system may use the class labels and persistent instance identifiers to count, monitor, or analyze the movement of people and goods within an environment. As described here, the class labels and object tracking data produced by video panoptic segmentation system 100 serve as actionable inputs enabling a wide range of practical, device-level and application-level operations.

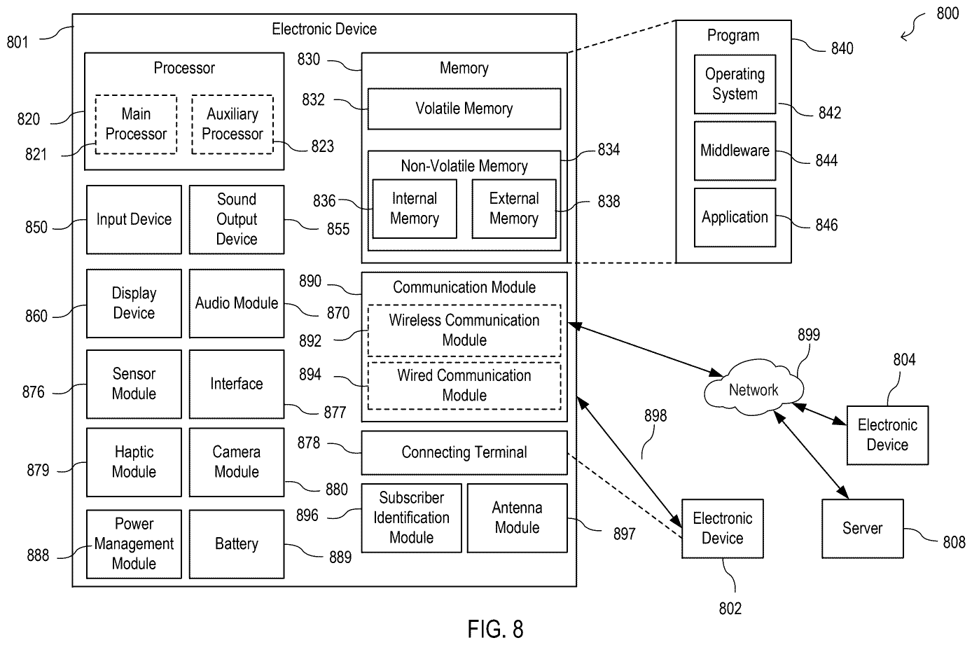

For further explanation, FIG. 8 is a block diagram of an electronic device in a network environment 800, according to an embodiment. In some embodiments, any of the preceding flowcharts may be carried out by various components of the electronic device of FIG. 8.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Those of skill in the art will appreciate that the operations described with respect to FIGS. 1-7 may be performed by various components of the electronic device such as processor 820. Main processor 821 may execute software instructions of program 840 to control the overall operation of video panoptic segmentation system 100, while auxiliary processor 823 (e.g., an NPU, GPU, or ISP) may execute the deep-learning computations associated with CNN encoder 102, pixel decoder 104, transformer decoder 114, tracking refiner 122, and online tracker 124. Memory 830 may store feature maps, embeddings, and mask predictions generated during execution of the methods. Camera module 880 may capture the sequence of video frames processed by CNN encoder 102. In some embodiments, output panoptic-segmentation results may be displayed on display device 860 or transmitted through communication module 890 to another electronic device or server 808 for further analysis.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
generating, by a convolutional neural network encoder of a video panoptic segmentation system, multi-scale feature maps from a sequence of video frames, wherein the video panoptic segmentation system further comprises a pixel decoder, a transformer decoder, and an online tracker;
refining the multi-scale feature maps to produce mask feature representations;
producing, by the transformer decoder, query embeddings and mask predictions from the mask feature representations refined by the pixel decoder;
matching, by the video panoptic segmentation system, the query embeddings for a current frame with query embeddings for a previous frame;
refining, by the online tracker, the query embeddings of the current frame based on the matched query embeddings of the previous frame; and
outputting, by the video panoptic segmentation system, panoptic-segmentation results based on the refined query embeddings that identify classes and instance associations across the sequence of video frames.

2. The method of claim 1, wherein the panoptic-segmentation results comprise a classification for each pixel into a semantic class and associations of pixels with persistent instance identifiers, each persistent instance identifier representing an object identified in multiple frames of the sequence of video frames.

3. The method of claim 1, wherein refining the multi-scale feature maps further comprises applying, within the pixel decoder, a transformer encoder and a feature-pyramid-network operation to combine feature maps of different spatial resolutions.

4. The method of claim 1, wherein producing the query embeddings and mask predictions further comprises applying, by the transformer decoder, a parametric-sigmoid-based masked-attention operation.

5. The method of claim 1, wherein generating the multi-scale feature maps further comprises applying batch-normalization operations in the convolutional neural network encoder.

6. The method of claim 1, wherein producing the query embeddings and mask predictions further comprises applying root-mean-square-normalization operations in the transformer decoder.

7. The method of claim 1, wherein refining the query embeddings of the current frame further comprises augmenting the query embeddings of the current frame with context embeddings derived from mask features prior to refinement.

8. The method of claim 7, wherein augmenting the query embeddings further comprises generating the context embeddings by applying a mask-pooling operation to the mask features using binarized sigmoid masks.

9. The method of claim 1, wherein refining the query embeddings of the current frame further comprises recursively incorporating information from query embeddings of one or more previous frames to update the query embeddings of the current frame.

10. The method of claim 1, wherein matching the query embeddings for the current and previous frames further comprises applying a Hungarian matching algorithm to associate query embeddings of the current frame with query embeddings of the previous frame prior to refinement.

11. The method of claim 1, wherein outputting the panoptic-segmentation results further comprises aggregating mask-classification logits across frames using a Hungarian-matching-based exponential-moving-average process to maintain temporal consistency in class predictions.

12. An apparatus comprising:
a memory; and
a processing device operatively coupled to the memory, the processing device configured to:
generate, by a convolutional neural network encoder of a video panoptic segmentation system, multi-scale feature maps from a sequence of video frames, wherein the video panoptic segmentation system further comprises a pixel decoder, a transformer decoder, and an online tracker;
refine the multi-scale feature maps to produce mask feature representations;
produce, by the transformer decoder, query embeddings and mask predictions from the mask feature representations refined by the pixel decoder;
match, by the video panoptic segmentation system, the query embeddings for a current frame with query embeddings for a previous frame;
refine, by the online tracker, the query embeddings of the current frame based on the matched query embeddings of the previous frame; and
output, by the video panoptic segmentation system, panoptic-segmentation results based on the refined query embeddings that identify classes and instance associations across the sequence of video frames.

13. The apparatus of claim 12, wherein the panoptic-segmentation results comprise a classification for each pixel into a semantic class and associations of pixels with persistent instance identifiers, each persistent instance identifier representing an object identified in multiple frames of the sequence of video frames.

14. The apparatus of claim 12, wherein the processing device is further configured to refine the multi-scale feature maps by applying, within the pixel decoder, a transformer encoder and a feature-pyramid-network operation to combine feature maps of different spatial resolutions.

15. The apparatus of claim 12, wherein the processing device is further configured to produce the query embeddings and mask predictions by applying, by the transformer decoder, a parametric-sigmoid-based masked-attention operation.

16. The apparatus of claim 12, wherein the processing device is further configured to generate the multi-scale feature maps by applying batch-normalization operations in the convolutional neural network encoder.

17. A computer program product comprising a computer-storage medium storing instructions that, when executed by a processing device, cause the processing device to:
generate, by a convolutional neural network encoder of a video panoptic segmentation system, multi-scale feature maps from a sequence of video frames, wherein the video panoptic segmentation system further comprises a pixel decoder, a transformer decoder, and an online tracker;
refine the multi-scale feature maps to produce mask feature representations;
produce, by the transformer decoder, query embeddings and mask predictions from the mask feature representations refined by the pixel decoder;
match, by the video panoptic segmentation system, the query embeddings for a current frame with query embeddings for a previous frame;
refine, by the online tracker, the query embeddings of the current frame based on the matched query embeddings of the previous frame; and
output, by the video panoptic segmentation system, panoptic-segmentation results based on the refined query embeddings that identify classes and instance associations across the sequence of video frames.

18. The computer program product of claim 17, wherein the panoptic-segmentation results comprise a classification for each pixel into a semantic class and associations of pixels with persistent instance identifiers, each persistent instance identifier representing an object identified in multiple frames of the sequence of video frames.

19. The computer program product of claim 17, wherein refining the multi-scale feature maps further comprises applying, within the pixel decoder, a transformer encoder and a feature-pyramid-network operation to combine feature maps of different spatial resolutions.

20. The computer program product of claim 17, wherein producing the query embeddings and mask predictions further comprises applying, by the transformer decoder, a parametric-sigmoid-based masked-attention operation.
